(19) United States
(12) Patent Application Publication
(10) Pub. No.: US 2021/0026193 A1
(43) Pub. Date: Jan. 28, 2021

(54) DISPLAY SUBSTRATE, MANUFACTURING METHOD THEREFOR, AND DISPLAY PANEL

(71) Applicant: BOE TECHNOLOGY GROUP CO., LTD., Beijing (CN)

(72) Inventors: Jing YU, Beijing (CN); Yu Ju CHEN, Beijing (CN); Gang YU, Beijing (CN)

(73) Assignee: BOE TECHNOLOGY GROUP CO., LTD., Beijing (CN)

(21) Appl. No.: 16/647,217

(22) PCT Filed: Apr. 24, 2019
(86) PCT No.: PCT/CN2019/084105

§ 371 Date: Mar. 13, 2020

(30) Foreign Application Priority Data
May 18, 2018 (CN) 201810481331.X

(51) Int. Cl. G02F 1/1335; G02F 1/13357

(52) U.S. Cl. CPC G02F 1/133516; G02F 2202/38; G02F 2202/36; G02F 1/133617

(57) ABSTRACT

The present disclosure provides a display substrate and a manufacturing method thereof, and a display panel. The method includes: providing a base substrate; forming a quantum dot material layer on the base substrate by using a mixture of a quantum dot material and ester compounds; enabling the ester compounds in the quantum dot material layer to react by a sol-gel method to form a sol-gel layer that is doped with nanoparticles; performing a curing processing on the sol-gel layer to obtain a quantum dot color film layer.

The present application claims priority of Chinese Patent Application No. 201810481331.X, filed on May 18, 2018, the disclosure of which is incorporated herein by reference in its entirety as part of the present application.

### TECHNICAL FIELD

Embodiments of the present disclosure relate to a display substrate and a manufacturing method thereof, and a display panel.

### BACKGROUND

A thin film transistor liquid crystal display (TFT-LCD) includes a liquid crystal panel, a backlight source, and a driving circuit board, the liquid crystal panel consists of an array substrate, a color film substrate, and a liquid crystal layer positioned between the array substrate and the color film substrate. TFT-LCD is a non-active light-emitting element, and requires the backlight source to provide a light source. The black and white gray scale display is formed by controlling a rotation angle of the liquid crystal, and a color display picture is formed by a color barrier layer on the color film substrate.

A traditional color film substrate achieves color display based on a filtering principle, and the color barrier layer on the color film substrate is prepared by a photoresist doped with dye particles. TFT-LCD achieves the color display by adjusting the transmittance of the light in a specific wavelength range through the color barrier layer, but in a case where this display mode is adopted, a utilization rate of backlight is low. Because quantum dots have characteristics of photoluminescence and high color purity, the usage of the quantum dots instead of the dye particles can achieve effects of improving the energy conversion efficiency of the backlight and increasing the display color gamut.

### SUMMARY

At least one embodiment of the present disclosure provides a manufacturing method of a display substrate, and the manufacturing method includes: providing a base substrate; forming a quantum dot material layer on the base substrate by using a quantum dot material that is mixed with ester compounds; enabling the ester compounds in the quantum dot material layer to react by a sol-gel method to form a sol-gel layer that is doped with nanoparticles; performing a curing processing on the sol-gel layer to obtain a quantum dot color film layer.

For example, the manufacturing method further includes: forming a black matrix on the base substrate, then forming the quantum dot material layer on the base substrate on which the black matrix has been formed; or forming an array circuit on the base substrate, then forming the quantum dot material layer on the base substrate on which the array circuit has been formed.

For example, forming the quantum dot material layer on the base substrate, on which the black matrix has been formed, by using the quantum dot material that is mixed with the ester compounds, includes: forming, by an ink jet printing method, the quantum dot material that is mixed with the ester compounds on the base substrate on which the black matrix has been formed to obtain the quantum dot material layer.

For example, the manufacturing method further includes: performing a water vapor pretreatment on the base substrate on which the black matrix has been formed, in an acidic environment or an alkaline environment.

For example, enabling the ester compounds in the quantum dot material layer to react by the sol-gel method, includes: performing a water vapor pretreatment on the base substrate on which the quantum dot material layer has been formed, in an acidic environment or an alkaline environment, so that the ester compounds in the quantum dot material layer undergoes a hydrolysis reaction.

For example, performing the curing processing on the sol-gel layer to obtain the quantum dot color film layer, includes: removing volatile substances in the sol-gel layer by using a heating method or a vacuuming method.

For example, performing the curing processing on the sol-gel layer to obtain the quantum dot color film layer, further includes: performing the curing processing on the sol-gel layer to obtain the quantum dot color film layer by using an ultraviolet irradiation method.

For example, the quantum dot material includes an aqueous resin material that is mixed with water-soluble quantum dots.

For example, a doping mass fraction of the water-soluble quantum dots relative to the aqueous resin material is 5-20%.

For example, the water-soluble quantum dots comprise at least one selected from a group consisting of a cadmium telluride, a cadmium selenide, and a zinc sulfide.

For example, the aqueous resin material comprises an aqueous acrylic resin material.

For example, a doping mass fraction of the ester compounds relative to the quantum dot material is 1-5%.

For example, the ester compounds comprise an ethyl orthosilicate, and the nanoparticles comprise silica particles.

For example, the ester compounds comprise a butyl titanate, and the nanoparticles comprise titanium dioxide particles.

At least one embodiment of the present disclosure further provides a display substrate, and the display substrate includes a base substrate and a quantum dot color film layer provided on the base substrate, the quantum dot color film layer is doped with nanoparticles, and the nanoparticles are generated from ester compounds after the ester compounds react by a sol-gel method.

For example, the base substrate is further provided with a black matrix, or the base substrate is further provided with an array circuit, and the quantum dot color film layer is provided on the array circuit.

At least one embodiment of the present disclosure further provides a display panel, and the display panel includes the display substrate described above.

For example, the display substrate is a color film substrate, and the display panel further comprises an array substrate, the color film substrate is provided opposite to the array substrate.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative to the present disclosure.

FIG. 1 is a flowchart of a manufacturing method of a display substrate provided by at least one embodiment of the preset disclosure;

FIG. 2A is a flowchart of a manufacturing method of a color film substrate provided by at least one embodiment of the preset disclosure;

FIG. 2B is a schematic diagram of a base substrate, on which a black matrix has been formed, in the manufacturing method as shown in FIG. 2A;

FIG. 2C is a schematic diagram of forming a quantum dot material layer in the manufacturing method as shown in FIG. 2A;

FIG. 2D is a schematic diagram of forming a sol-gel layer that is doped with nanoparticles in the manufacturing method as shown in FIG. 2A;

FIG. 3 is a structural schematic diagram of a color film substrate provided by at least one embodiment of the present disclosure;

FIG. 4 is a structural schematic diagram of a display panel provided by at least one embodiment of the present disclosure.

### DETAILED DESCRIPTION

In order to make the objects, technical schemes and advantages of the present disclosure more clear, the technical scheme of the embodiments of the present disclosure will be clearly and completely describe in conjunction with the accompanying drawings of the embodiments of the present disclosure. Obviously, described embodiments are part of the embodiments of the present disclosure, not all of the embodiments. Based on the described embodiments of the present disclosure, all of other embodiments acquired by those skilled in the art, without any inventive work, are fall within the scope of the protection of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

A quantum dot color film layer (also known as a color barrier layer) is usually manufactured by a wet preparation process, and in a case where the concentration of quantum dots is too low, the conversion rate of backlight is low, resulting in low color purity; in a case where the concentration of the quantum dots is too high, the preparation cost of a color film substrate is higher, and the light yield of the quantum dots is lower. At present, the nanoparticles with a scattering function are usually added to the quantum dot material with low concentration to improve the conversion rate of the backlight.

However, after adding the nanoparticles to the quantum dot material, the nanoparticles are separated out from the quantum dot material due to the limitation of the sizes of the nanoparticles and the sizes of spray holes of a ink jet printer, so that the quantum dot color film layer cannot be formed by using the ink jet printing technology, and the manufacturing method of the quantum dot color film layer is highly restrictive.

At least one embodiment of the present disclosure provides a manufacturing method of a display substrate, and the manufacturing method includes: providing a base substrate; forming a quantum dot material layer on the base substrate by using a quantum dot material that is mixed with ester compounds; enabling the ester compounds in the quantum dot material layer to react by a sol-gel method to form a sol-gel layer that is doped with nanoparticles; performing a curing processing on the sol-gel layer to obtain a quantum dot color film layer.

At least one embodiment of the present disclosure further provides a display substrate, the display substrate is obtained, for example, by using the manufacturing method of the display substrate provided by at least one embodiment of the present disclosure. For example, the display substrate includes: a base substrate and a quantum dot color film layer provided on the base substrate, the quantum dot color film layer is doped with nanoparticles, and the nanoparticles are generated from ester compounds after the ester compounds react by a sol-gel method. For example, the display substrate may be a color film substrate or an array substrate.

Various embodiments of the present disclosure will be described below with reference to the accompanying drawings.

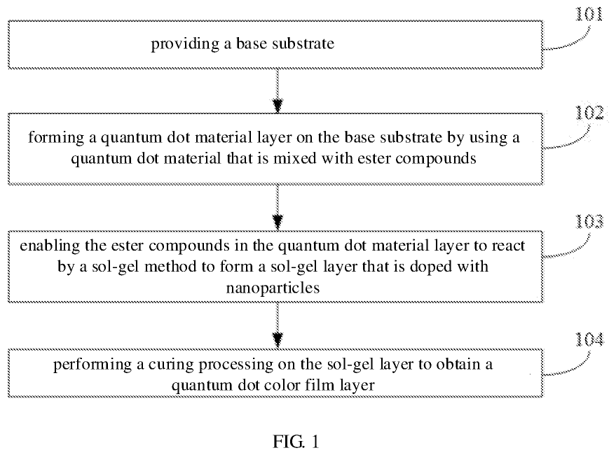

Embodiments of the present disclosure provide a manufacturing method of a display substrate, as shown in FIG. 1, the method may include the following steps.

Step 101: providing a base substrate.

For example, the base substrate may be made of transparent materials such as glass, silicon, quartz, and plastic, etc.

Step 102: forming a quantum dot material layer on the base substrate by using a quantum dot material that is mixed with ester compounds.

For example, a water vapor pretreatment may be performed on the base substrate, so that a layer of water is formed on the base substrate to accelerate subsequent hydrolysis reaction of the ester compounds.

For example, the water vapor pretreatment may be performed on the base substrate in a first acidic environment or a first alkaline environment, that is, the water vapor pretreatment may be performed on the base substrate by using water vapor mixed with acid or alkali to further accelerate the subsequent hydrolysis reaction of the ester compounds.

For example, the time for performing the water vapor pretreatment on the base substrate may be 3 minutes to 5 minutes.

Step 103: enabling the ester compounds in the quantum dot material layer to react by a sol-gel method to form a sol-gel layer that is doped with nanoparticles.

Step 104: performing a curing processing on the sol-gel layer to obtain a quantum dot color film layer.

In summary, the manufacturing method of the display substrate provided by the above embodiments of the present disclosure includes the following steps: firstly, forming the quantum dot material layer on the base substrate by using the quantum dot material that is mixed with the ester compounds, secondly, enabling the ester compounds in the quantum dot material layer to react by a sol-gel method to form a sol-gel layer that is doped with nanoparticles, and finally, performing a curing processing on the sol-gel layer to obtain a quantum dot color film layer. In the embodiment, the quantum dot color film layer includes nanoparticles. Therefore, it is not necessary to directly dope nanoparticles in the quantum dot material, but to generate nanoparticles in the quantum dot material layer by the sol-gel method, after forming the quantum dot material layer, to obtain the final quantum dot color film layer.

In different embodiments of the present disclosure, the quantum dot material layer can be formed either by a spin coating method or by an ink jet printing method, thereby enriching the manufacturing method of the quantum dot color film layer, while ensuring the conversion rate of backlight, and the manufacturing flexibility of the quantum dot color film layer is high.

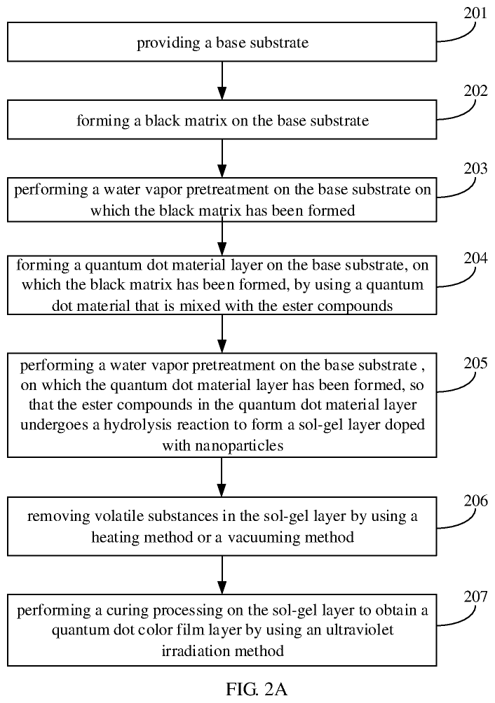

Another embodiment of the present disclosure provides a manufacturing method of a color film substrate, as shown in FIG. 2A to FIG. 2D, the method may include the following steps.

Step 201: providing a base substrate.

For example, the base substrate may be made of transparent materials such as glass, silicon, quartz, and plastic, etc.

Step 202: forming a black matrix on the base substrate. The base substrate 10, on which the black matrix 20 has been formed, is shown in FIG. 2B, and the black matrix 20 includes a plurality of openings respectively corresponding to sub-pixels, and then a color film layer will be formed in these openings. In this example, a common color film substrate can be obtained.

In another example, an array circuit is formed on the base substrate, and then a quantum dot material layer is formed on the base substrate, on which the array circuit has been formed, that is, the array circuit is first formed to obtain an array substrate, and the quantum dot material layer is formed on the array substrate to obtain the array substrate of a color-filter on array (COA) type. For example, the array circuit includes pixel units arranged in an array and signal lines, such as gate lines, data lines, and the like, configured for the pixel units. The pixel electrode of each of the pixel units is configured to apply an electric field to control the degree of rotation of a liquid crystal material to perform a display operation, or each of the pixel units includes organic light-emitting material stacked layers, and the pixel electrode of each of the pixel units serves as an anode or a cathode to drive the organic light-emitting material to emit light to perform the display operation.

The following description will continue to take the common color film substrate as an example, and will not specifically describe the array substrate of the COA type. However, it is to be understood that, for the array substrate of the COA type, the black matrix may also be formed on the base substrate before or after forming the array circuit. The black matrix includes a plurality of openings respectively corresponding to the sub-pixels, and then the color film layer will be formed in these openings.

For example, a black matrix material layer may be formed on the base substrate by using a black matrix material, and then the black matrix 20 may be formed by a patterning process. For example, the patterning process includes photoresist coating, exposure, development, etching, and photoresist stripping.

For example, materials for forming the black matrix 20 include a black resin (for example, the acrylic resin doped with carbon black), a dark metal oxide (for example, a chromium oxide), etc.

Step 203: performing a water vapor pretreatment on the base substrate on which the black matrix has been formed.

An example of performing the water vapor pretreatment on the base substrate, on which the black matrix has been formed, includes: performing pretreatment on the base substrate, on which the black matrix has been formed, by using water vapor, so that a layer of water is formed on the base substrate, on which the black matrix has been formed, so as to accelerate subsequent hydrolysis reaction of the ester compounds.

For example, the water vapor pretreatment is performed on the base substrate, on which the black matrix has been formed, in a first acidic environment or a first alkaline environment, that is, the pretreatment may be performed on the base substrate, on which the black matrix has been formed, by using water vapor mixed with acid or alkali to further accelerate the subsequent hydrolysis reaction of the ester compounds.

For example, the time for performing the water vapor pretreatment on the base substrate, on which the black matrix has been formed, may be 3 minutes to 5 minutes.

Step 204: forming a quantum dot material layer on the base substrate, on which the black matrix has been formed, by using a quantum dot material that is mixed with the ester compounds. A schematic diagram of forming a quantum dot material layer 30 is shown in FIG. 2C.

For example, the quantum dot material that is mixed with the ester compounds is formed on the base substrate 10, on which the black matrix 20 has been formed, by the ink jet printing method, to obtain the quantum dot material layer 30. Or, the quantum dot material that is mixed with the ester compounds may also be formed on the base substrate 10, on which the black matrix 20 has been formed, by a spin coating method. The embodiments of the present disclosure does not limit the method of forming the quantum dot material layer 30.

The ester compounds provided by this embodiment of the present disclosure refers to compounds that can react by the sol-gel method to generate nanoparticles, for example, the ester compound may include ethyl orthosilicate and/or butyl titanate.

For example, the quantum dot material includes the resin material that is mixed with quantum dots. The doping mass fraction of the quantum dots relative to the resin material may be 5%-20%, for example, 8%-15%. The doping mass fraction of the ester compounds relative to the quantum dot material layer may be 1%-5%, for example, 1.5%-3.5%. By adjusting the viscosity, the surface tension, and the solubility in the quantum dot material of the ester compounds, the quantum dot material mixed with the ester compounds can be prepared into quantum dot ink that can be used for printing, so that the quantum dot material layer can be formed by an ink jet printing method.

Step 205: performing a water vapor pretreatment on the base substrate 10, on which the quantum dot material layer 30 has been formed, so that the ester compounds in the quantum dot material layer 10 undergoes a hydrolysis reaction to form a sol-gel layer 50 doped with nanoparticles 40. A schematic diagram of forming the sol-gel layer 50 doped with the nanoparticles 40 is shown in FIG. 2D.

Performing the water vapor pretreatment on the base substrate 10, on which the quantum dot material layer 30 has been formed, refers to that the water vapor is injected into the quantum dot material layer 30, so that ester compounds undergo the hydrolysis reaction after contacting with the water vapor. For example, the water vapor pretreatment is performed on the base substrate 10, on which the quantum dot material layer 30 has been formed, in the second acidic environment or the second alkaline environment, that is, the water vapor mixed with acid or alkali is injected into the quantum dot material layer 30 to accelerate the hydrolysis reaction of the ester compounds and shorten the reaction time.

In at least one embodiment of the present disclosure, the first acidic environment or the first alkaline environment may be the same as or different from the second acidic environment or the second alkaline environment.

In at least one embodiment of the present disclosure, both the first acidic environment and the second acidic environment are formed by using nitric acid, and the nitric acid may be removed under subsequent high temperature conditions. It is also possible to use other acids, as long as an acidic reaction environment can be provided and the acids are easy to be removed.

In at least one embodiment of the present disclosure, both the first alkaline environment and the second alkaline environment are formed by using ammonia water, and the ammonia radicals of the ammonia water may be removed under the subsequent high temperature conditions. It is also possible to use other alkaline substances as long as the alkaline reaction environment can be provided and the alkaline substances are easy to be removed.

For example, the time of performing the water vapor pretreatment on the base substrate 10, on which the quantum dot material layer 30 has been formed, may be 10 minutes to 30 minutes.

For example, the ester compounds include the ethyl orthosilicate, and the nanoparticles 40 include silica particles, and/or the ester compounds include the butyl titanate, and the nanoparticles 40 include titanium dioxide particles. The nanoparticles can have a scattering effect on incident light (such as the backlight emitted by a backlight module in a display device), so as to increase the number of the backlight irradiated onto the quantum dots, thereby improving the conversion rate of the backlight.

It should note that, because the ester compounds need to undergo the hydrolysis reaction under the catalysis of water, the aqueous resin material mixed with water-soluble quantum dots can be selected as the quantum dot material, to facilitate to inject water vapor into the quantum dot material layer 30, thereby shortening the reaction time.

For example, the water-soluble quantum dots may include at least one selected from a group consisting of cadmium telluride, cadmium selenide, and zinc sulfide. The aqueous resin material may include an aqueous acrylic resin material, and the aqueous acrylic resin material has photo-curing characteristic.

Step 206: removing volatile substances in the sol-gel layer.

For example, excess water and other volatile liquids in the sol-gel layer can be removed by using a heating method or a vacuuming method, to ensure the stability of the finally formed sol-gel layer.

Step 207: performing a curing processing on the sol-gel layer to obtain a quantum dot color film layer.

For example, the curing processing is performed on the sol-gel layer to obtain the quantum dot color film layer by using an ultraviolet irradiation method. In a case where the aqueous acrylic resin material with the photo-curing characteristic is used as a raw material of the quantum dot material, the quantum dot color film layer can be effectively cured through the ultraviolet irradiation, the thickness range of the finally formed quantum dot color film layer is 5 μm-10 μm, the residual solvent is less than 0.1 wt %, the visible light absorbance of the resin material is less than 5%, and the light conversion rate at a corresponding wavelength is more than 90%, and the finally formed quantum dot color film layer has higher structural stability.

It should be noted that the sequence of steps in the manufacturing method of the display substrate provided by at least one embodiment of the present disclosure can be appropriately adjusted, and the steps can also be correspondingly increased or decreased according to the situations. Any person skilled in the art can easily think of various change methods within the technical scope disclosed in the present disclosure, the various change methods should be covered within the protection scope of the present disclosure, and thus are not repeated here.

In summary, the manufacturing method of the display substrate provided by at least one embodiment of the present disclosure, includes the following steps: firstly, forming the quantum dot material layer by using the quantum dot material mixed with the ester compounds, secondly, enabling the ester compounds in the quantum dot material layer to react by a sol-gel method to form a sol-gel layer that is doped with nanoparticles, and finally, performing a curing processing on the sol-gel layer to obtain a quantum dot color film layer. In the embodiment, the quantum dot color film layer includes nanoparticles. Therefore, it is not necessary to directly dope nanoparticles in the quantum dot material, but to generate nanoparticles in the quantum dot material layer by the sol-gel method, after forming the quantum dot material layer, to obtain the final quantum dot color film layer.

In different embodiments of the present disclosure, the quantum dot material layer can be formed either by a spin coating method or by an ink jet printing method, thereby enriching the manufacturing method of the quantum dot color film layer, while ensuring the conversion rate of backlight, and the manufacturing flexibility of the quantum dot color film layer is high.

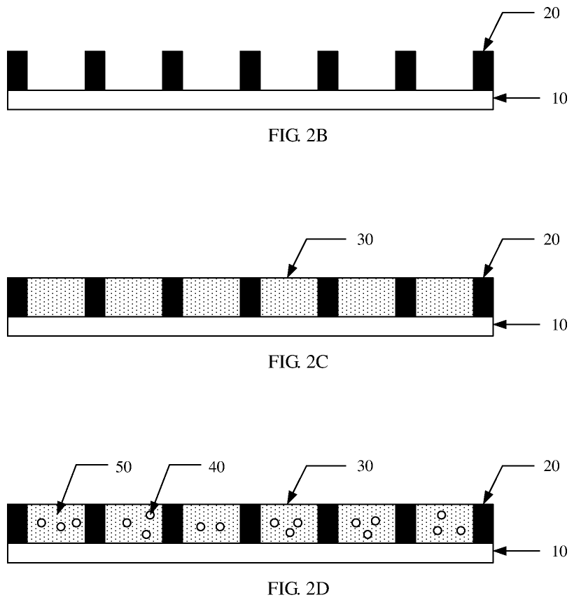

Embodiments of the present disclosure provide a display substrate, as shown in FIG. 3, the display substrate includes a base substrate 10 and a quantum dot color film layer 60 disposed on the base substrate 10. The quantum dot color film layer 60 is doped with nanoparticles, and according to any one of embodiments of the present disclosure, the nanoparticles are generated from ester compounds after the ester compounds react by a sol-gel method. The display substrate may be a color film substrate or an array substrate (for example, the array substrate of COA type).

For example, referring to FIG. 3, the quantum dot color film layer may include a red color barrier R, a green color barrier G, and a blue color barrier B. In practical applications, the quantum dot color film layer may also include color barrier of other colors, and the present disclosure is not limited in this aspect.

Also, as shown in FIG. 3, the color film substrate may further include a black matrix 20, and the black matrix 20 is formed in a predetermined pattern to separate the red color barrier R, the green color barrier G, and the blue color barrier B of adjacent sub-pixel units from each other. For another example, the black matrix 20 and the quantum dot color film layer 60 are sequentially disposed on the base substrate 10. For example, the red color barrier R, the green color barrier G, and the blue color barrier B of the quantum dot color film layer 60, for example, at least partially overlap with the black matrix 20 in a direction perpendicular to the base substrate 10.

For example, the display substrate provided by the embodiments of the present disclosure can be applied to a display panel.

In summary, for the display substrate provided by at least one embodiment of the present disclosure, in the manufacturing process, the following steps are included: firstly, forming the quantum dot material layer by using the quantum dot material mixed with the ester compounds, secondly, enabling the ester compounds in the quantum dot material layer to react by a sol-gel method to form a sol-gel layer that is doped with nanoparticles, and finally, performing a curing processing on the sol-gel layer to obtain a quantum dot color film layer. In the embodiment, the quantum dot color film layer includes nanoparticles. Therefore, it is not necessary to directly dope nanoparticles in the quantum dot material, but to generate nanoparticles in the quantum dot material layer by the sol-gel method, after forming the quantum dot material layer, to obtain the final quantum dot color film layer.

In various embodiments of the present disclosure, the quantum dot material layer can be formed either by a spin coating method or by an ink jet printing method, thereby enriching the manufacturing method of the quantum dot color film layer, while ensuring the conversion rate of backlight, and the manufacturing flexibility of the quantum dot color film layer is high.

Regarding the display substrate in the above embodiments, the specific manufacturing method of each film layer has been described in detail in the embodiments of the manufacturing method, and will not be described in detail here.

Embodiments of the present disclosure provide a display panel including the color film substrate of any one of the above embodiments.

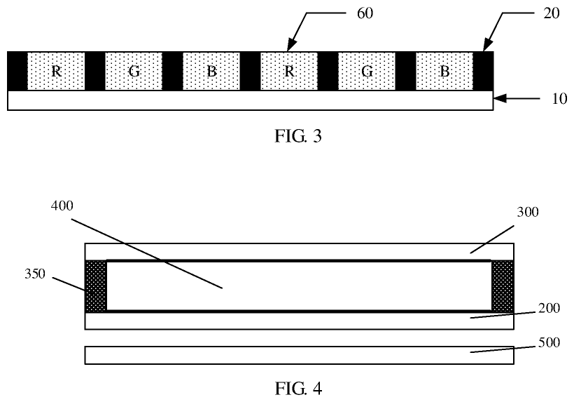

As shown in FIG. 4, an example of the display panel is a liquid crystal display panel, and the liquid crystal display panel includes an array substrate 200, a color film substrate 300 opposite to the array substrate 200, and a liquid crystal layer 400 sandwiched between the array substrate 200 and the color film substrate 300. The array substrate 200 and the color film substrate are opposed to each other and are combined with each other by the frame sealing adhesive 350 to form a liquid crystal cell, the liquid crystal cell is filled with a liquid crystal material of the liquid crystal layer 400. The array substrate includes the array circuit, and the array circuit includes the pixel units arranged in an array and signal lines, such as gate lines, data lines, and the like, configured for the pixel units. The pixel electrode of each of the pixel units is configured to apply an electric field to control the degree of rotation of the liquid crystal material to perform a display operation. In some examples, the liquid crystal display panel further includes a backlight source 500 that provides the backlight for the display operations.

Another example of the display panel is an organic light-emitting diode (OLED) display panel, and the OLED display panel includes an array substrate and a color film substrate stacked on the array substrate. For example, the array substrate includes an array circuit, the array circuit includes pixel units arranged in an array and signal lines, such as gate lines, data lines, and the like, configured for these pixel units, each of the pixel units includes organic light-emitting material stacked layers, and the pixel electrode of each of the pixel units serves as an anode or a cathode to drive the organic light-emitting material to emit light to perform the display operation.

At least one embodiment of the present disclosure further provides a display panel, the display panel includes an array substrate and a quantum dot color film layer provided on the array substrate. In the embodiments, the quantum dot color film layer is doped with nanoparticles, and according to the descriptions of the above embodiments, the nanoparticles are generated from the ester compounds after the ester compounds react by a sol-gel method. In these embodiments, the quantum dot color film layer is formed directly on the array substrate instead of on the color film substrate, and then the color film substrate is bonded to the array substrate. In these embodiments, the array substrate functions as the base substrate in the above embodiments. That is, the array substrate is the array substrate of the COA type, and the quantum dot color film layer is directly formed on the array circuit. For example, the array circuit includes the pixel units arranged in an array and signal lines, such as gate lines, data lines, and the like, configured for the pixel units. The pixel electrode of each of the pixel units is configured to apply an electric field to control the degree of rotation of a liquid crystal material to perform a display operation, or each of the pixel units includes organic light-emitting material stacked layers, and the pixel electrode of each of the pixel units serves as an anode or a cathode to drive the organic light-emitting material to emit light to perform the display operation.

The display panel of at least one embodiment of the present disclosure may be applied to a display device, and the display device may be any product or component having a display function, such as an electronic paper, a mobile phone, a tablet computer, a television, a monitor, a notebook computer, a digital photo frame, and a navigator.

The beneficial effects of the display panel provided by at least one embodiment of the present disclosure are the same as those of the above-mentioned display substrate, and will not be repeated here.

What are described above are merely exemplary implementations of the present disclosure, and are not intended to limit the protection scope of the present disclosure. The protection scope of the present disclosure should be determined by the appended claims.

1: A manufacturing method of a display substrate, comprising:
providing a base substrate;
forming a quantum dot material layer on the base substrate by using a mixture of a quantum dot material and ester compounds;
enabling the ester compounds in the quantum dot material layer to react by a sol-gel method to form a sol-gel layer that is doped with nanoparticles; and
performing a curing processing on the sol-gel layer to obtain a quantum dot color film layer.

2: The method according to claim 1, wherein before forming the quantum dot material layer on the base substrate, the method further comprises:
forming a black matrix on the base substrate; or
forming an array circuit on the base substrate.

3: The method according to claim 1, wherein
forming the quantum dot material layer on the base substrate by using the mixture of the quantum dot material and the ester compounds comprises:
forming, by an ink jet printing method, the mixture of the quantum dot material and the ester compounds on the base substrate to obtain the quantum dot material layer.

4: The method according to claim 1, before forming the quantum dot material layer on the base substrate, further comprising:
performing a water vapor pretreatment on the base substrate in a first acidic environment or a first alkaline environment.

5: The method according to claim 1, wherein enabling the ester compounds in the quantum dot material layer to react by the sol-gel method comprises:
performing a water vapor pretreatment on the base substrate on which the quantum dot material layer has been formed, in a second acidic environment or a second alkaline environment, so that the ester compounds in the quantum dot material layer undergoes a hydrolysis reaction.

6: The method according to claim 1, wherein performing the curing processing on the sol-gel layer to obtain the quantum dot color film layer comprises:
removing volatile substances in the sol-gel layer by using a heating method or a vacuuming method.

7: The method according to claim 6, wherein performing the curing processing on the sol-gel layer to obtain the quantum dot color film layer further comprises:
performing the curing processing on the sol-gel layer to obtain the quantum dot color film layer by using an ultraviolet irradiation method.

8: The method according to claim 1, wherein the quantum dot material comprises water-soluble quantum dots and an aqueous resin material that is mixed with the water-soluble quantum dots.

9: The method according to claim 8, wherein a doping mass fraction of the water-soluble quantum dots relative to the aqueous resin material is 5%-20%.

10: The method according to claim 8, wherein the water-soluble quantum dots comprise at least one selected from a group consisting of a cadmium telluride, a cadmium selenide, and a zinc sulfide.

11: The method according to claim 8, wherein the aqueous resin material comprises an aqueous acrylic resin material.

12: The method according to claim 1, wherein a doping mass fraction of the ester compounds relative to the quantum dot material is 1%-5%.

13: The method according to claim 1, wherein the ester compounds comprise an ethyl orthosilicate, and the nanoparticles comprise silica particles.

14: The method according to claim 1, wherein the ester compounds comprise a butyl titanate, and the nanoparticles comprise titanium dioxide particles.

15: A display substrate, comprising:
a base substrate;
a quantum dot color film layer provided on the base substrate, wherein the quantum dot color film layer is doped with nanoparticles, and the nanoparticles are generated from ester compounds after the ester compounds react by a sol-gel method.

16: The display substrate according to claim 15, wherein the base substrate is further provided with a black matrix, or
the base substrate is further provided with an array circuit, and the quantum dot color film layer is provided on the array circuit.

17: A display panel, comprising a display substrate,
wherein the display substrate comprises a base substrate and a quantum dot color film layer provided on the base substrate;
the quantum dot color film layer is doped with nanoparticles, and the nanoparticles are generated from ester compounds after the ester compounds react by a sol-gel method.

18: The display panel according to claim 17, wherein the display substrate is a color film substrate, and
the display panel further comprises an array substrate, and the color film substrate is provided opposite to the array substrate.

19: The method according to claim 2, wherein enabling the ester compounds in the quantum dot material layer to react by the sol-gel method comprises:
performing a water vapor pretreatment on the base substrate on which the quantum dot material layer has been formed, in a second acidic environment or a second alkaline environment, so that the ester compounds in the quantum dot material layer undergoes a hydrolysis reaction.

20: The method according to claim 2, wherein performing the curing processing on the sol-gel layer to obtain the quantum dot color film layer comprises:
removing volatile substances in the sol-gel layer by using a heating method or a vacuuming method.
